(19) United States
(12) Patent Application Publication
(10) Pub. No.: US 2019/0126535 A1
(43) Pub. Date: May 2, 2019

(54) CARTRIDGE PLATE-BASED ADDITIVE MANUFACTURING APPARATUS AND METHOD

(71) Applicant: General Electric Company, Schenectady, NY (US)

(72) Inventor: Mary Kathryn Thompson, North Huntingdon, PA (US)

(21) Appl. No.: 15/802,309

(22) Filed: Nov. 2, 2017

(51) Int. Cl. B29C 64/135; B29C 64/245; B29C 64/264; B33Y 10/00; B33Y 30/00

(52) U.S. Cl. CPC B29C 64/135; B29C 64/245; B33Y 30/00; B33Y 10/00; B29C 64/264

(57) ABSTRACT

An additive manufacturing apparatus includes: a build plate, at least a portion of which is transparent, the build plate defining a build surface; a plate transport mechanism operable to selectively move the build plate into or out of a build zone defined within the apparatus; a material depositor operable to deposit a curable resin on the build surface; a stage positioned adjacent the build zone and configured to hold a stacked arrangement of one or more cured layers of the resin; a mechanism operable to manipulate a relative position of the build plate and the stage; and a radiant energy apparatus positioned adjacent to the build zone opposite to the stage, and operable to generate and project radiant energy through the build plate in a predetermined pattern. A method is provided for use of the apparatus.

### BACKGROUND OF THE INVENTION

This invention relates generally to additive manufacturing, and more particularly to methods for curable material handling in additive manufacturing.

Additive manufacturing is a process in which material is built up layer-by-layer to form a component. Stereolithography is a type of additive manufacturing process which employs a vat of liquid radiant-energy curable photopolymer “resin” and a curing energy source such as a laser. Similarly, DLP 3D printing employs a two-dimensional image projector to build components one layer at a time. For each layer, the projector flashes a radiation image of the cross-section of the component on the surface of the liquid or through a transparent object which defines a constrained surface of the resin. Exposure to the radiation cures and solidifies the pattern in the resin and joins it to a previously-cured layer or to another build surface.

In curing the photopolymer resin, it is preferable to have a fresh supply of material for each layer. Old resin may contain cured products such as supports that have broken off of the part or other external contamination. In a vat-based process, this contamination or the contaminated material can cure into the component, resulting in undesirable geometry, or otherwise disrupt the build process and damage the final part.

Another prior art method is a so-called “tape casting” process. In this process, a resin is deposited onto a flexible radiotransparent tape that is fed out from a supply reel. An upper plate lowers on to the resin, compressing it between the tape and the upper plate and defining a layer thickness. Radiant energy is used to cure the resin through the radiotransparent tape. Once the curing of the first layer is complete, the upper plate is retracted upwards, taking the cured material with it. The tape is then advanced to expose a fresh clean section, ready for additional resin. One problem with tape casting is that it is wasteful because the tape is often not reusable.

### BRIEF DESCRIPTION OF THE INVENTION

At least one of these problems is addressed by an additive manufacturing method in which material is deposited and cured on a plate. A fresh plate is provided in sequence for each curing cycle.

According to one aspect of the technology described herein, an additive manufacturing apparatus includes: a build plate, at least a portion of which is transparent, the build plate defining a build surface; a plate transport mechanism operable to selectively move the build plate into or out of a build zone defined within the apparatus; a material depositor operable to deposit a radiant-energy-curable resin on the build surface; a stage positioned adjacent the build zone and configured to hold a stacked arrangement of one or more cured layers of the resin; a mechanism operable to manipulate a relative position of the build plate and the stage; and a radiant energy apparatus positioned adjacent to the build zone opposite to the stage, and operable to generate and project radiant energy through the build plate in a predetermined pattern.

According to another aspect of the technology described herein, a method for producing a component layer-by-layer includes the steps of: preparing a build plate including at least a portion which is transparent, the build plate defining a build surface which has a radiant-energy-curable resin deposited thereupon; within a build zone of an additive manufacturing apparatus, positioning a stage relative to the build surface so as to define a layer increment in the resin; selectively curing the resin, using an application of radiant energy in a specific pattern so as to define the geometry of a cross-sectional layer of the component; moving the build plate and the stage relatively apart so as to separate the component from the build surface; transporting the build plate out of the build zone; and repeating the steps of preparing, positioning, curing, and transporting for a plurality of layers until the component is complete.

### BRIEF DESCRIPTION OF THE DRAWINGS

The invention may be best understood by reference to the following description taken in conjunction with the accompanying drawing figures in which:

FIG. 1 is a schematic side elevation view of an exemplary additive manufacturing apparatus;

FIG. 2 is a schematic side elevation view of an alternative additive manufacturing apparatus;

FIG. 3 is a schematic diagram showing an optional release agent spray head;

FIG. 4 is a schematic diagram showing an optional release film applicator;

FIG. 5 is a view of the apparatus of FIG. 1, showing resin being deposited onto a build plate thereof;

FIG. 6 is a schematic top plan view of a layer of resin having multiple sections applied using the apparatus of FIG. 1;

FIG. 7 is a view of the apparatus of FIG. 1, showing a stage lowered into place and resin being cured using a radiant energy apparatus;

FIG. 8 is a view of the apparatus of FIG. 1, showing a stage retracted;

FIG. 9 is a view of the apparatus of FIG. 1, showing a build plate moved out of a build zone of the apparatus;

FIG. 10 is a schematic side elevation view of an alternative additive manufacturing apparatus;

FIG. 11 is a view of the apparatus of FIG. 1, showing a vat moved into position in a build zone of the apparatus;

FIG. 12 is a schematic perspective view of a build plate having a layer of resin applied thereto;

FIG. 13 is a schematic side elevation view of a stage and a vat containing cleaning fluid; and

FIG. 14 is a schematic side elevation view of a stage in an empty vat equipped with air nozzles.

### DETAILED DESCRIPTION OF THE INVENTION

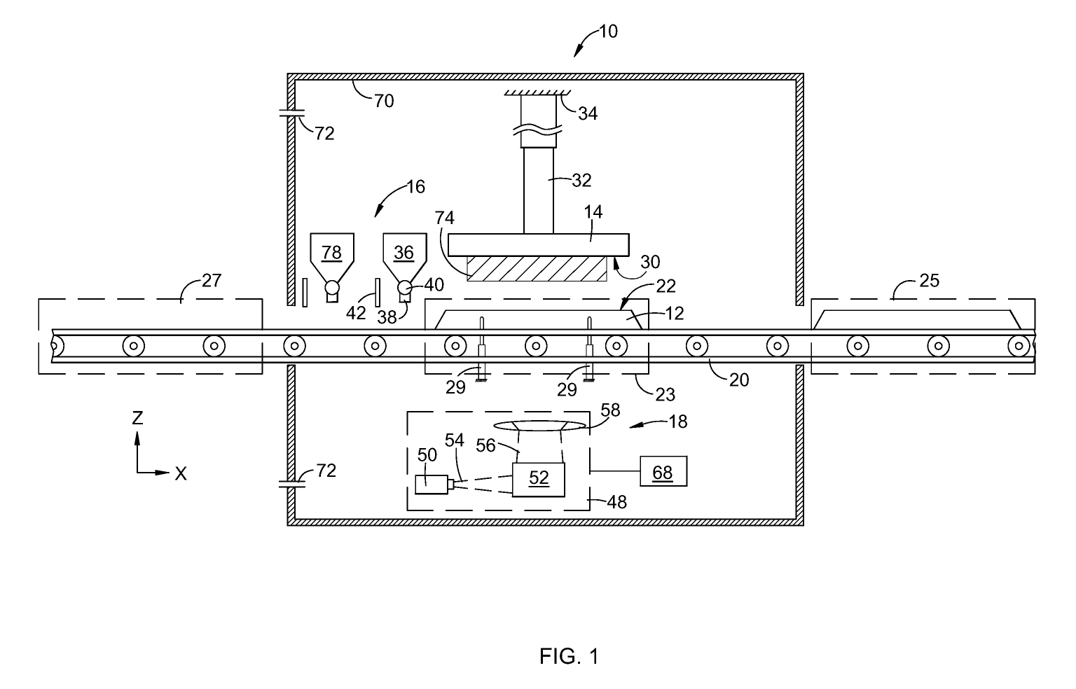

Referring to the drawings wherein identical reference numerals denote the same elements throughout the various views, FIG. 1 illustrates schematically an example of one type of suitable apparatus 10 for carrying out an embodiment of an additive manufacturing method as described herein. As will be explained in more detail below, it will be understood that other configurations of equipment may be used to carry out the method described herein. Basic components of the exemplary apparatus 10 include a build plate 12, a stage 14, a radiant energy apparatus 18, and a plate transport mechanism 20. Each of these components will be described in more detail below.

The build plate 12 defines a planar build surface 22. For purposes of convenient description, the build surface 22 may be considered to be oriented parallel to an X-Y plane of the apparatus 10, and a direction perpendicular to the X-Y plane is denoted as a Z-direction (X, Y, and Z being three mutually perpendicular directions).

The build plate 12 is sufficiently stiff, such that, under the expected loads applied during an additive manufacturing process, it does not bend or deflect enough to interfere with the additive manufacturing process, or cause an unacceptable amount of distortion or inaccuracy in the component being produced. The desired stiffness may be provided through a combination of material properties (i.e. a sufficiently high modulus) and/or component design (i.e. thickness, stiffening features, etc.).

The build plate 12, or selected portions of it, are transparent. As used herein, “transparent” refers to a material which allows radiant energy of a selected wavelength to pass through. For example, as described below, the radiant energy used for curing could be ultraviolet light or laser light in the visible spectrum. Nonlimiting examples of transparent materials include polymers, glass, and crystalline minerals such as sapphire or quartz. The build plate 12 could be made up of two or more subcomponents, some of which are transparent.

The build surface 22 may be configured to be “non-stick”, that is, resistant to adhesion of cured resin. The non-stick properties may be embodied by a combination of variables such as the chemistry of the build plate 12, its surface finish, and/or applied coatings. In one example, a permanent or semi-permanent non-stick coating may be applied. One nonlimiting example of a suitable coating is polytetrafluoroethylene (“PTFE”). In one example, all or a portion of the build surface 22 may incorporate a controlled roughness or surface texture (e.g. protrusions, dimples, grooves, ridges, etc.) with nonstick properties. In one example, the build plate 12 may be made in whole or in part from an oxygen-permeable material.

The stage 14 is a structure defining a planar upper surface 30 which is capable of being oriented parallel to the build surface 22 during the layer orientation and curing steps described below. Some means are provided for moving the build plate 12 relative to the stage 14 parallel to the Z-direction. In FIG. 1, these means are depicted schematically as a simple actuator 32 connected between the stage 14 and a stationary support structure 34, with the understanding that devices such as pneumatic cylinders, hydraulic cylinders, ballscrew electric actuators, linear electric actuators, or delta drives may be used for this purpose. In addition to, or as an alternative to, making the stage 14 movable, the build plate 12 and/or the transport mechanism 20 could be movable parallel to the Z-direction.

An area or volume immediately surrounding the location of the build plate 12 (when it is positioned for a curing step to take place) is defined as a “build zone”, denoted by a dashed-line box 23. For purposes of description, the apparatus 10 may be associated with a “loading zone” 25 positioned in near proximity to the build zone 23, and an “unloading zone” 27 positioned in near proximity to the build zone 23. (Alternatively, a single buffer or staging zone may be provided). The plate transport mechanism 20 comprises a device or combination of devices operable to move a build plate 12 from the loading zone 25 into the build zone 23, or from the build zone 23 into the unloading zone 27.

In the illustrated example, one possible plate transport mechanism 20 is shown in the form of a conveyor belt which extends laterally through the build zone 23. Other types of mechanisms suitable for this purpose include, for example, mechanical linkages, rotary tables, or robot effector arms. It will be understood that the build plates 12 may be moved into or out of the build zone from any desired direction.

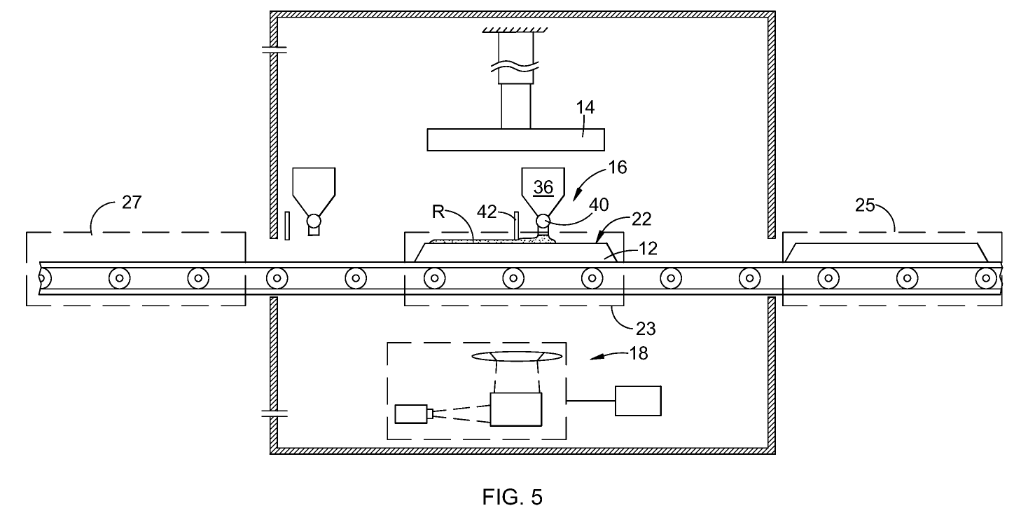

The apparatus 10 is particularly adapted to a first embodiment of an additive build method and includes a material depositor 16 in close proximity to the build zone 23. The material depositor 16 may be any device or combination of devices which is operable to apply a layer of resin R (FIG. 5) over the build plate 12 and to level the resin R. Nonlimiting examples of suitable material depositors include chutes, hoppers, pumps, spray nozzles, spray bars, or printheads (e.g. inkjets).

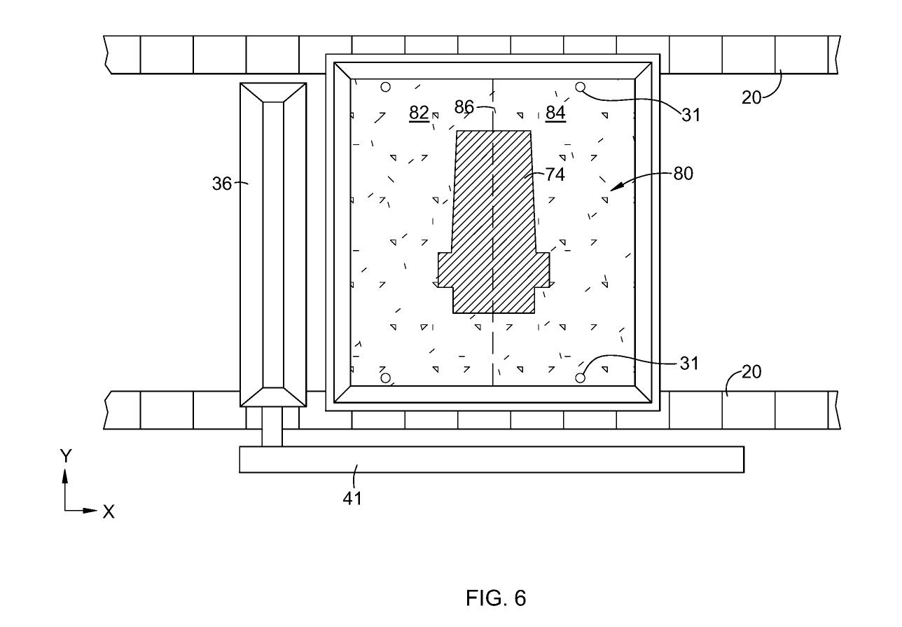

In the example shown in FIG. 1, the material depositor 16 comprises a supply container 36 with a nozzle 38 and a valve 40. Appropriate means are provided for moving the material depositor 16 laterally over the build surface 22, such as the actuator 41 seen in FIG. 6, to deposit resin R. Generally, the resin would also include a filler. Optionally, the resin R could be used without a filler, provided the resin has a high enough viscosity so that it will not run off the build surface 22. Means may be provided for leveling the applied resin R. In the example shown in FIG. 1, the material depositor 16 includes a recoater 42 which is a laterally-elongated structure. This may be rigidly fixed to the supply container 36 or may be connected to a separate actuator (not shown).

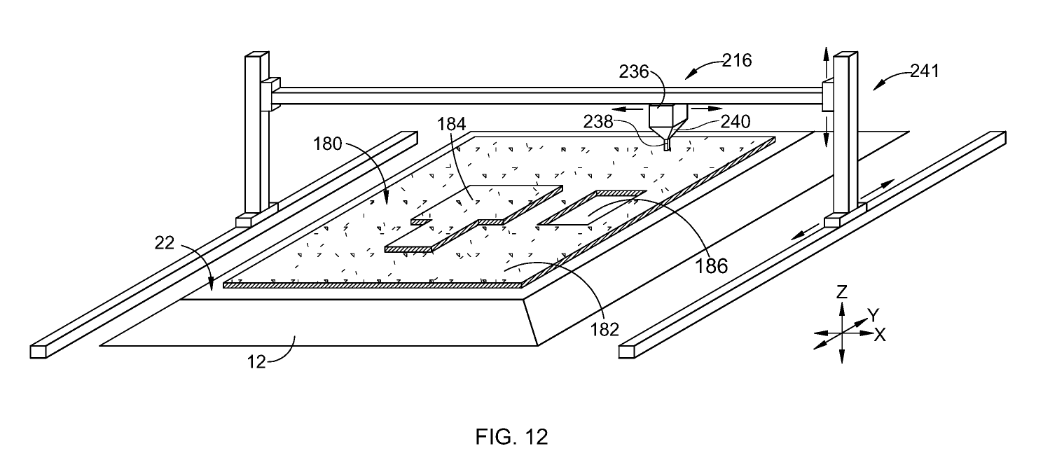

FIG. 12 illustrates an example of yet another suitable type of material depositor 216 comprising a supply container 236 with a nozzle 238 and a flow control mechanism 240. Appropriate means are provided for controlled 3D movement of the material depositor 216 over the build surface 22 (e.g. in X, Y, Z axes). FIG. 12 shows an actuator assembly 241 as an example. As explained in more detail below, this type of material depositor 216 is capable of depositing resin R in layers having arbitrary shapes and variable thickness.

Other types of material depositors may be used; for example, one or more rollers (not shown) may be provided to move and level the resin R. Optionally, the resin R may be leveled by vibrating the build plate 12.

The radiant energy apparatus 18 may comprise any device or combination of devices operable to generate and project radiant energy on the resin R in a suitable pattern and with a suitable energy level and other operating characteristics to cure the resin R during the build process, described in more detail below.

In one exemplary embodiment as shown in FIG. 1, the radiant energy apparatus 18 may comprise a “projector” 48, used herein generally to refer to any device operable to generate a radiant energy patterned image of suitable energy level and other operating characteristics to cure the resin R. As used herein, the term “patterned image” refers to a projection of radiant energy comprising an array of individual pixels. Nonlimiting examples of patterned imaged devices include a DLP projector or another digital micromirror device, a 2D array of LEDs, a 2D array of lasers, or optically addressed light valves. In the illustrated example, the projector 48 comprises a radiant energy source 50 such as a UV lamp, an image forming apparatus 52 operable to receive a source beam 54 from the radiant energy source 50 and generate a patterned image 56 to be projected onto the surface of the resin R, and optionally focusing optics 58, such as one or more lenses.

The radiant energy source 50 may comprise any device operable to generate a beam of suitable energy level and frequency characteristics to cure the resin R. In the illustrated example, the radiant energy source 50 comprises a UV flash lamp.

The image forming apparatus 52 may include one or more mirrors, prisms, and/or lenses and is provided with suitable actuators, and arranged so that the source beam 54 from the radiant energy source 50 can be transformed into a pixelated image in an X-Y plane coincident with the surface of the resin R. In the illustrated example, the image forming apparatus 52 may be a digital micromirror device. For example, the projector 48 may be a commercially-available Digital Light Processing (“DLP”) projector.

As an option, the projector 48 may incorporate additional means such as actuators, mirrors, etc. configured to selectively move the image forming apparatus 52 or other part of the projector 48, with the effect of rastering or shifting the location of the patterned image 56 of the build surface 22. Stated another way, the patterned image may be moved away from a nominal or starting location. This permits a single image forming apparatus 52 to cover a larger build area, for example. Means for mastering or shifting the patterned image from the image forming apparatus 52 are commercially available. This type of image projection may be referred to herein as a “tiled image”.

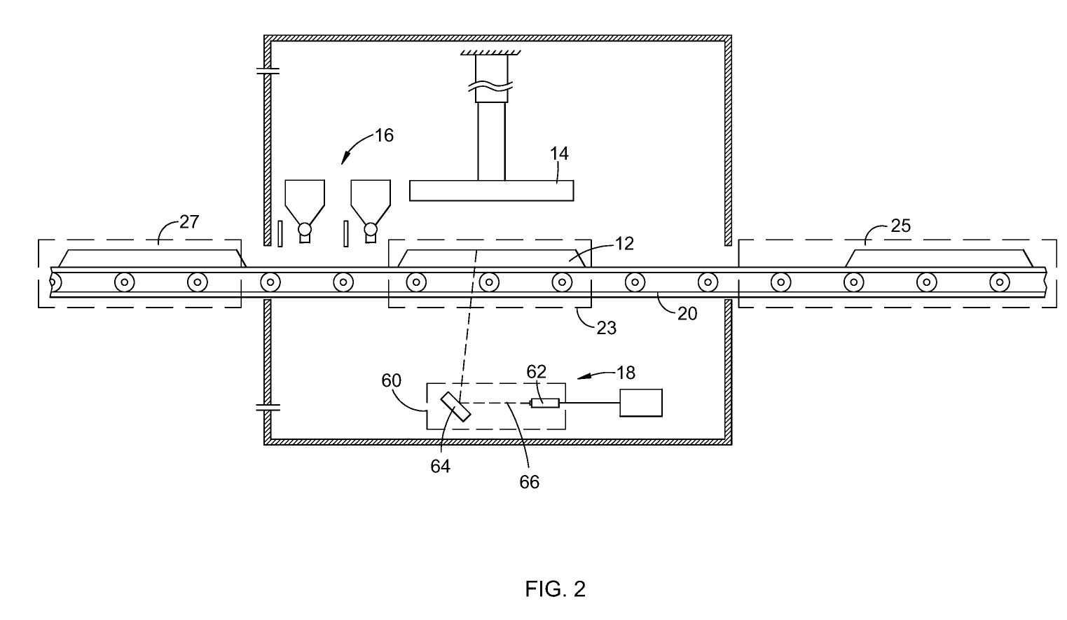

In another exemplary embodiment as shown in FIG. 2, the radiant energy apparatus 18 may comprise a “scanned beam apparatus” 60 used herein to refer generally to any device operable to generate a radiant energy beam of suitable energy level and other operating characteristics to cure the resin R and to scan the beam over the surface of the resin R in a desired pattern. In the illustrated example, the scanned beam apparatus 60 comprises a radiant energy source 62 and a beam steering apparatus 64.

The radiant energy source 62 may comprise any device operable to generate a beam of suitable power and other operating characteristics to cure the resin R. Nonlimiting examples of suitable radiant energy sources include lasers or electron beam guns.

The beam steering apparatus 64 may include one or more mirrors, prisms, and/or lenses and may be provided with suitable actuators, and arranged so that a beam 66 from the radiant energy source 62 can be focused to a desired spot size and steered to a desired position in plane coincident with the surface of the resin R. The beam 66 may be referred to herein as a “build beam”. Other types of scanned beam apparatus may be used. For example, scanned beam sources using multiple build beams are known, as are scanned beam sources in which the radiant energy source itself is movable by way of one or more actuators.

The apparatus 10 may include a controller 68. The controller 68, FIG. 1, is a generalized representation of the hardware and software required to control the operation of the apparatus 10, including some or all of the material depositor 16, the stage 14, the radiant energy apparatus 18, the transport mechanism 20, and the various actuators described above. The controller 68 may be embodied, for example, by software running on one or more processors embodied in one or more devices such as a programmable logic controller (“PLC”) or a microcomputer. Such processors may be coupled to sensors and operating components, for example, through wired or wireless connections. The same processor or processors may be used to retrieve and analyze sensor data, for statistical analysis, and for feedback control.

Optionally, the components of the apparatus 10 may be surrounded by a housing 70, which may be used to provide a shielding or inert gas atmosphere using gas ports 72. Optionally, pressure within the housing could be maintained at a desired level greater than or less than atmospheric. Optionally, the housing 70 could be temperature and/or humidity controlled. Optionally, ventilation of the housing 70 could be controlled based on factors such as a time interval, temperature, humidity, and/or chemical species concentration.

The resin R comprises a material which is radiant-energy curable and which is capable of adhering or binding together the filler (if used) in the cured state. As used herein, the term “radiant-energy-curable” refers to any material which solidifies in response to the application of radiant energy of a particular frequency and energy level. For example, the resin R may comprise a known type of photopolymer resin containing photo-initiator compounds functioning to trigger a polymerization reaction, causing the resin to change from a liquid state to a solid state. Alternatively, the resin R may comprise a material which contains a solvent that may be evaporated out by the application of radiant energy. The uncured resin R may be provided in solid (e.g. granular) or liquid form including a paste or slurry.

Generally, the resin R should be flowable so that it can be leveled on the build surface 22. A suitable resin R will be a material that is relatively thick, i.e. its viscosity should be sufficient that it will not run off of the build plate 12 during the curing process. The composition of the resin R may be selected as desired to suit a particular application. Mixtures of different compositions may be used.

The resin R may be selected to have the ability to out-gas or burn off during further processing, such as the sintering process described above.

The filler may be pre-mixed with resin R, then loaded into the material depositor 16. The filler comprises particles, which are conventionally defined as “a very small bit of matter”. The filler may comprise any material which is chemically and physically compatible with the selected resin R. The particles may be regular or irregular in shape, may be uniform or non-uniform in size, and may have variable aspect ratios. For example, the particles may take the form of powder, of small spheres or granules, or may be shaped like small rods or fibers.

The composition of the filler, including its chemistry and microstructure, may be selected as desired to suit a particular application. For example, the filler may be metallic, ceramic, polymeric, and/or organic. Other examples of potential fillers include diamond, silicon, and graphite. Mixtures of different compositions may be used.

The filler may be “fusible”, meaning it is capable of consolidation into a mass upon application of sufficient energy. For example, fusibility is a characteristic of many available powders including but not limited to: polymeric, ceramic, glass, and metallic.

The proportion of filler to resin R may be selected to suit a particular application. Generally, any amount of filler may be used so long as the combined material is capable of flowing and being leveled, and there is sufficient resin R to hold together the particles of the filler in the cured state.

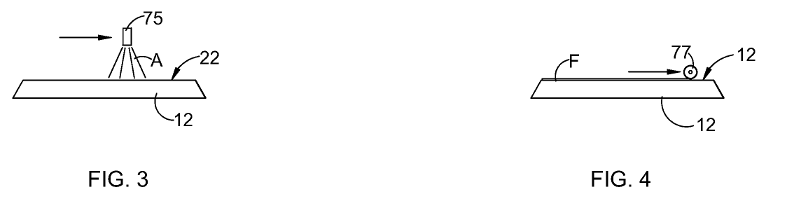

Examples of the operation of the apparatus 10 will now be described in detail with reference to FIGS. 3-9. It will be understood that, as a precursor to producing a component and using the apparatus 10, the component 74 (FIG. 1) is software modeled as a stack of planar layers arrayed along the Z-axis. Depending on the type of curing method used, each layer may be divided into a grid of pixels. The actual component 74 may be modeled and/or manufactured as a stack of dozens or hundreds of layers. Suitable software modeling processes are known in the art.

Initially (in this embodiment) the transport mechanism 20 is used to move a fresh build plate 12 from the loading zone 25 into the build zone 23 optionally, alignment means (pins, guides, kinematic couplings etc.) may be provided to ensure repeatable positioning (e.g. location and orientation) of the build plate 12 within the build zone 23. In the illustrated example (see FIGS. 1 and 6), retractable pins 29 which register with corresponding blind holes 31 in the build plate 12 are shown.

Optionally, a nonstick material may be applied to the build surface 22 prior to resin application. For example, a release agent such as polyvinyl alcohol (“PVA”) may be applied to the build surface 22 prior to each layer being built. FIG. 3 shows a release agent “A” being applied to the build surface 22 by a moving spray nozzle 75. In another example, a sacrificial layer having non-stick properties may be applied. FIG. 4 shows a nonstick film “F” (e.g. polymer sheet or film) being laid down on the build surface 22 by a moving roller 77. The film F may be removed after a layer is cured as described below. Optionally, to prevent sticking, some means could be provided to supply oxygen through the thickness of the build plate 12, in order to inhibit curing of the resin R immediately adjacent the build surface 22 (oxygen can inhibit the curing of UV-curable resins).

The material depositor 16 is used to apply resin R to the build surface 22. In the example shown in FIG. 5, the valve 40 is open and resin flows over the build plate 12 as the material depositor 16 translates laterally above the build plate 12, and the recoater 42 levels the resin R. In this embodiment of the process, the steps of transporting the build plate 12 into the build zone 23 and applying resin R to the build surface 22 constitute “preparing” the build plate 12.

Optionally, different layers may comprise two or more different material combinations of resin R and/or filler. As used herein, the term “material combination” refers to any difference in either of the constituents. So, for example, a particular resin composition mixed with either of two different filler compositions would represent two different material combinations. For example, one layer may comprise a first combination of resin R and filler, and a second layer may comprise a different combination of resin R and filler. Stated another way, any desired resin and any desired filler can be used for any given layer. The different materials may be provided, for example, by providing one or more additional supply containers 78, as seen in FIG. 1.

Optionally, any of the individual layers may comprise two or more material combinations. FIG. 6 illustrates an exemplary layer 80 showing a cross-section of the component 74 superimposed thereupon. The layer 80 is divided into a first section 82 including a first combination of resin R and filler, and a second section 84 including a second combination of resin R and filler. A dashed line 86 indicates the division between the two sections 82, 84. The shape, size, and number of sections, and number of different material combinations within a given layer may be arbitrarily selected. If multiple material combinations are used in one layer, then the deposition steps described above would be carried out for each section of the layer.

Optionally, the layer may have a variable thickness. For example, FIG. 12 illustrates an exemplary layer 180 having some areas (exemplified by section 182) having a relatively smaller thickness and other areas (exemplified by section 184) having relatively larger thickness. The layer 180 may also include areas devoid of material (exemplified by open area 186). The shape of the various sections of layer may be arbitrary, as exemplified by the raised section 184. This type of variable-thickness layer may be applied, for example, using the material depositor 216 described above.

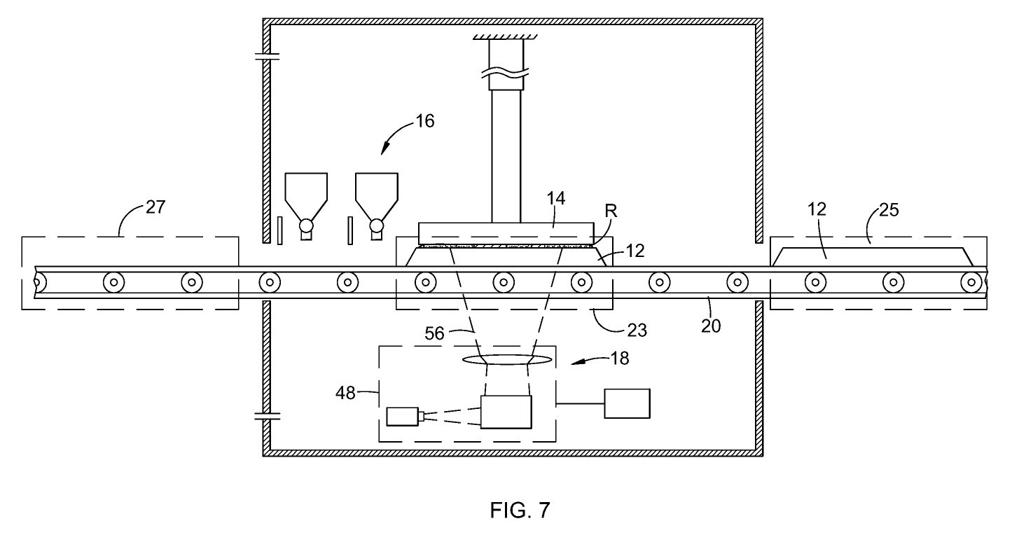

After the material is deposited, or as an integral part of the deposition step, the apparatus 10 is positioned to define a selected layer increment. The layer increment is defined by some combination of the thickness that the resin R is applied by the material depositor 16 (including optionally the operation of the recoater 42), or the operation of the stage 14. For example, the stage 14 could be positioned such that the upper surface 30 is just touching the applied resin R, or the stage 14 could be used to compress and displace the resin R to positively define the layer increment, see FIG. 7. The layer increment affects the speed of the additive manufacturing process and the resolution of the component 74. The layer increment can be variable, with a larger layer increment being used to speed the process in portions of a component 74 not requiring high accuracy, and a smaller layer increment being used where higher accuracy is required, at the expense of process speed.

Once the resin R with filler has been applied and the layer increment defined, the radiant energy apparatus 18 is used to cure a two-dimensional cross-section or layer of the component 74 being built.

Where a projector 48 is used, the projector 48 projects a patterned image 56 representative of the cross-section of the component 74 through the build plate 12 to the resin R. Exposure to the radiant energy cures and solidifies the pattern in the resin R. This type of curing is referred to herein as “selective” curing. It will be understood that photopolymers undergo degrees of curing. In many cases, the radiant energy apparatus 18 would not fully cure the resin R. Rather, it would partially cure the resin R enough to “gel” and then a post-cure process (described below) would cure the resin R to whatever completeness it can reach. It will also be understood that, when a multi-layer component is made using this type of resin R, the energy output of the radiant energy apparatus 18 may be carefully selected to partially cure or “under-cure” a previous layer, with the expectation that when the subsequent layer is applied, the energy from that next layer will further the curing of the previous layer. In the process described herein, the term “curing” or “cured” may be used to refer to partially-cured or completely-cured resin R. During the curing process, radiant energy may be supplied to a given layer in multiple steps (e.g. multiple flashes) and also may be supplied in multiple different patterns for a given layer. This allows different amounts of energy to be applied to different parts of a layer.

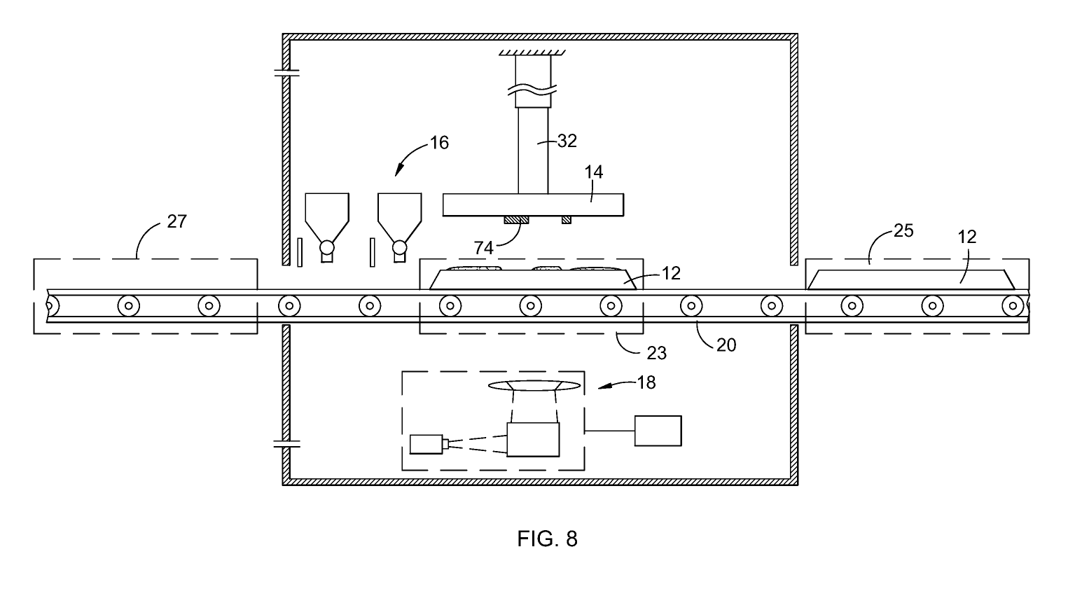

Once curing of the first layer is complete, the stage 14 is separated from the build plate 12, for example, by raising the stage 14 using the actuator 32 (FIG. 8). It is noted that stage 14 and the build plate 12 do not necessarily have to remain parallel during the separation procedure. For example, rotation of the stage 14 and/or the build plate 12 may be effected, e.g. using a pinned joint or a flexure, or through small-scale deformations of the build plate 12. This flexing or rotation could be helpful in separating cured resin from the build plate 12.

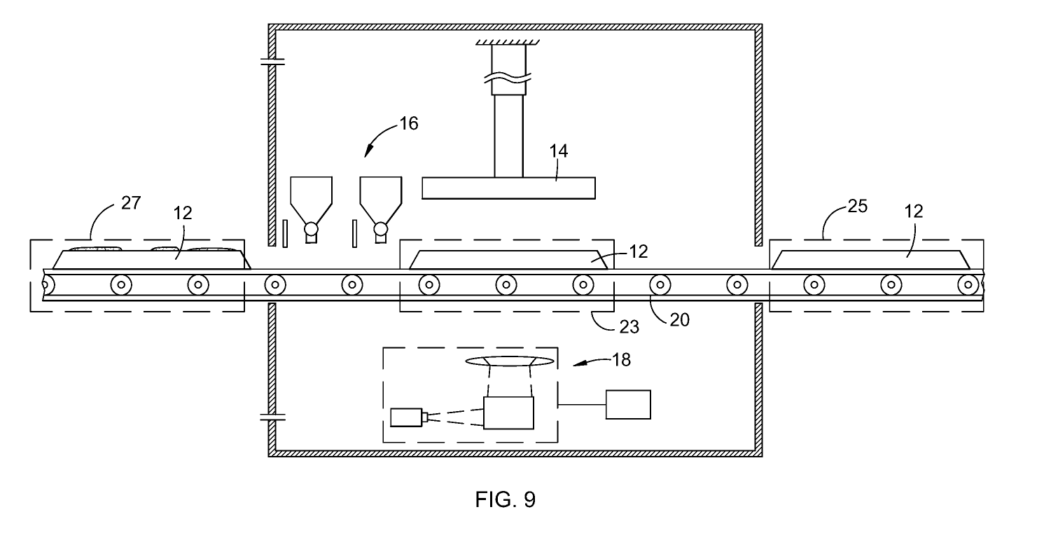

Once the stage 14 is separated from the build plate 12, the transport mechanism 20 is used to move the now-used build plate 12 out of the build zone 23 and into the unloading zone 27 (see FIG. 9).

Subsequent to unloading, the used build plate 12 may be cleaned or otherwise rejuvenated and prepared for re-use by removing uncured resin R and other debris from the build surface 22. Nonlimiting examples of suitable cleaning processes include brushing, abrading, scraping, vacuuming or blowing, absorbing, wiping, solvent rinsing, or combinations thereof.

The particular process or mechanism used to clean or otherwise rejuvenate the build plate 12 is not specifically relevant to the present invention. The time required for the selected rejuvenation process may be taken into account when determining the initial quantity of fresh build plates 12 needed such that the build process (specifically the curing step) would not have to be limited other than by the time required for the transport mechanism 20 to move a fresh build plate 12 from the loading zone 25 to the build zone 23. Alternatively, the used build plate 12 could be discarded, sent to an outside facility for reprocessing, or recycled.

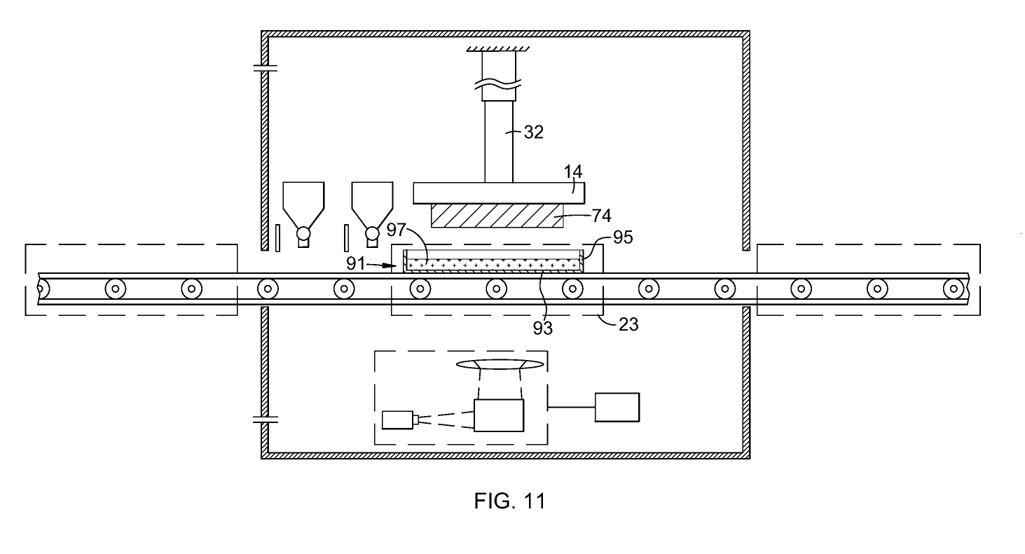

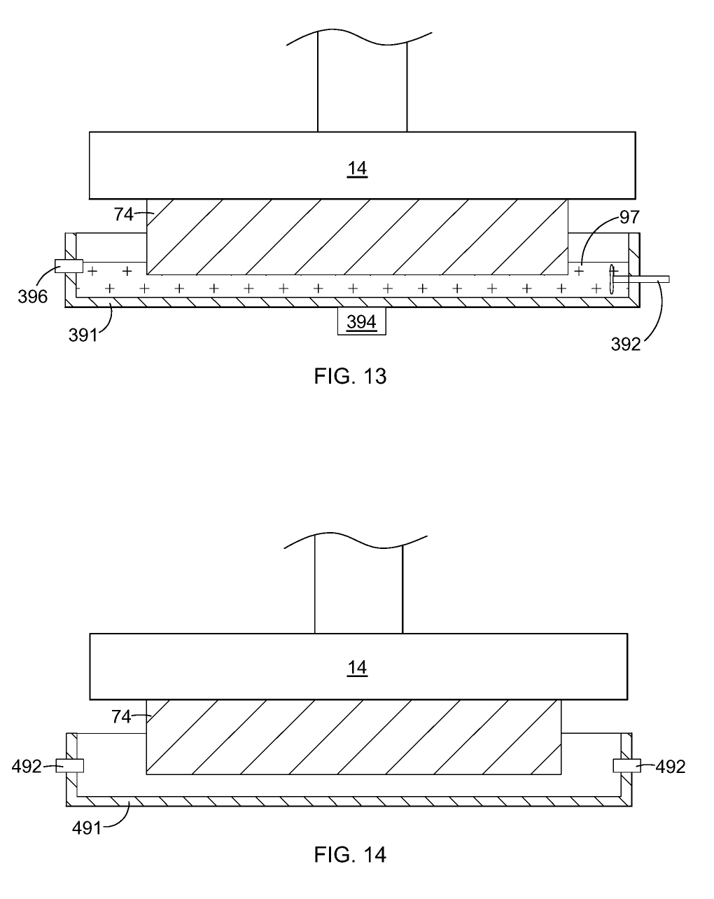

Optionally, the component 74 and/or the stage 14 may be cleaned to remove uncured resin R, debris, or contaminants between curing cycles. The cleaning process may be used for the purpose of removing resin R that did not cure or resin R that did not cure enough to gel during the selective curing step described above. For example, it might be desired to clean the component 74 and/or the stage 14 to ensure that no additional material or material contamination is present in the final component 74. For example, cleaning could be done by contacting the component 74 and/or the stage 14 with a cleaning fluid such as a liquid detergent or solvent. FIG. 11 shows one example of how this could be accomplished by providing a cleaning vat 91 containing the cleaning fluid. The cleaning vat 91 comprises a floor 93 surrounded by a peripheral wall 95. In use, the cleaning fluid 97 would be placed in the cleaning vat 91. The transport mechanism 20 would be used to move the cleaning vat 91 into the build zone 23. The stage 14 would then be lowered to bring the component 74 into contact with the cleaning fluid 97. Upon completion of the cleaning cycle, the stage 14 would then be raised to move the component 74 clear of the cleaning vat 91. Optionally, the cleaning process may include the introduction of some type of relative motion between the cleaning fluid 97 and the component 74. FIG. 13 illustrates a cleaning vat 391 (generally similar to cleaning vat 91) incorporating several different possible means for producing this relative motion. As one example, a mechanical mixing blade 392 may be used to agitate the cleaning fluid 97. As another example, an ultrasonic transducer 394 coupled to the cleaning vat 391 may be used to produce ultrasonic waves in the cleaning fluid 97. As another example, one or more nozzles 396 may be used to introduce jets of flowing cleaning fluid 97. As yet another example, appropriate actuators (not shown) may be used to produce relative motion of the stage 14 and the cleaning vat 391. Optionally, the cleaning process may include a “drying” step in which the freshly cleaned component 74 is positioned within an empty cleaning vat 491 (FIG. 14) with air nozzles 492 which would be used to direct jets of air at the component 74 for the purpose of blowing off or evaporating the cleaning fluid. Depending on the particular circumstances, the “drying” step may be sufficient to clean the component 74 in and of itself. Subsequent to the cleaning step, the transport mechanism 20 would then be used to move the cleaning vat 91 out of the build zone 23.

The transport mechanism 20 is used to move a fresh build plate 12 into the build zone 23 (this movement may be concurrent with the removal of the used build plate 12). Resin R with filler is applied to the fresh build plate 12, and another layer increment is defined. The projector 48 again projects a patterned image 56. Exposure to the radiant energy selectively cures resin R as described above, and joins the new layer to the previously-cured layer above. This cycle of loading a build plate 12, applying resin R, incrementing a layer, selectively curing, and unloading the build plate 12 is repeated until the entire component 74 is complete. In this process the build plates 12 function akin to “cartridges”, and this process may be described as “cartridge-based”.

Where a scanned beam apparatus is used instead of a projector, the radiant energy source 62 emits a beam 64 and the beam steering apparatus 70 is used to cure the resin R by steering a focal spot of the build beam 66 over the exposed resin R in an appropriate pattern. The cycle of loading a build plate 12, applying resin R, and incrementing a layer is repeated. The radiant energy source 62 again emits a build beam 64 and the beam steering apparatus 70 is used to steer the focal spot of the build beam 66 over the exposed resin R in an appropriate pattern. The exposed layer of the resin R is exposed to the radiant energy which selectively cures resin R as described above, and joins it to the previously-cured layer above. This cycle of loading a build plate 12, applying resin R, incrementing a layer, and selectively curing, and unloading the build plate 12 is repeated until the entire workpiece 74 is complete.

Optionally, a scanned beam apparatus may be used in combination with a projector. For example, a scanned beam apparatus may be used to apply radiant energy (in addition to that applied by the projector) by scanning one or multiple beams over the surface of the exposed particulate material P. This may be concurrent or sequential with the use of the projector.

Any of the curing methods described above results in a component 74 in which the filler (if used) is held in a solid shape by the cured resin R. This component may be usable as an end product for some conditions. Subsequent to the curing step, the component 74 may be removed from the stage 14.

If the end product is intended to be composed of the filler (e.g. purely ceramic, glass, metallic, diamond, silicon, graphite, etc.), the component 74 may be treated to a conventional sintering process to burn out the resin R and to consolidate the filler particles. Optionally, a known infiltration process may be carried out during or after the sintering process, in order to fill voids in the component with a material having a lower melting temperature than the filler. The infiltration process improves component physical properties.

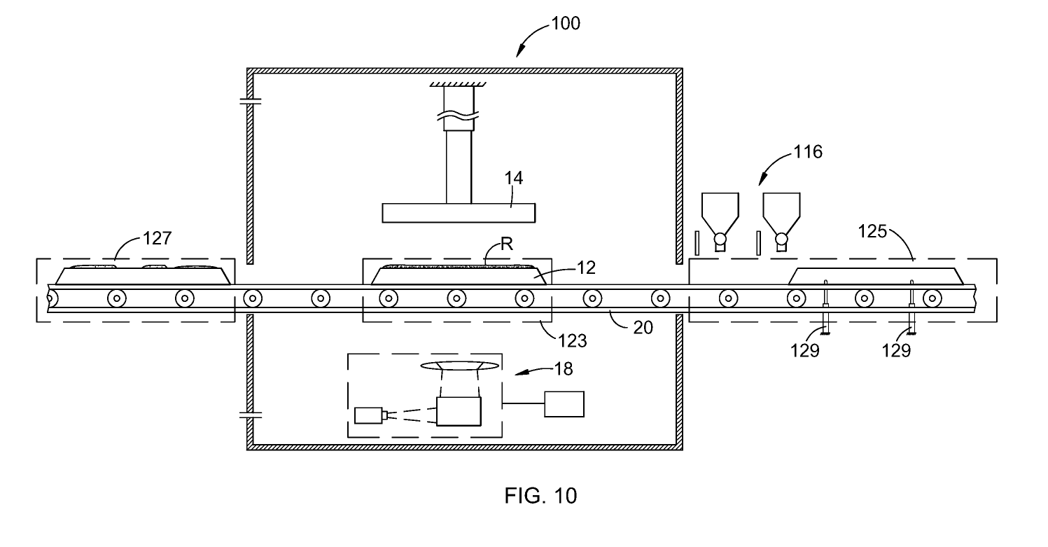

FIG. 10 illustrates schematically an example of a suitable apparatus 100 for carrying out another embodiment of an additive manufacturing method. Basic components of the exemplary apparatus 100 include a build plate 12, a stage 14, a material depositor 116 (or a depositor 216 such as shown in FIG. 12), a radiant energy apparatus 18, and a plate transport mechanism 20. The apparatus 100 has a build zone 123, loading zone 125, and unloading zone 127.

The apparatus 100 is similar to the apparatus 10 in construction and may utilize several of the same components. Any elements of the apparatus 100 not explicitly described may be considered to be identical to the corresponding components of apparatus 10.

The operation of the apparatus 100 is similar to that of the apparatus 10 described above, with the primary difference being that resin R is not deposited on the build plate 12 within the build zone 123. In this particular example, a material depositor 116 is shown positioned outside of the build zone 123 (i.e. upstream in the sequence).

To begin the build process, resin R with filler may be deposited on the build plate 12. In this example, the deposition occurs within the loading zone 125. However, it will be understood that the material deposition could occur at any location, and the loaded build plates 12 could then be brought to the vicinity of the apparatus 100. The transport mechanism 120 is then used to move the build plate into the build zone 123. In this embodiment, the deposition of resin R and transport of the build plate 12 into the build zone 123 constitute “preparing” the build plate 12. The resin layer is the cured using the radiant energy apparatus 18 as described above.

Concurrently with the curing step, resin R and optional filler is deposited on additional build plate 12 within the loading zone 125.

Once the curing cycle is complete, the transport mechanism 20 is used to move the “used” build plate 12 into the unloading zone 127. It can then be unloaded and could be cleaned or rejuvenated as described above, or discarded, sent to an outside facility for reprocessing, or recycled.

The additional build plate 12, having had resin R deposited, is then moved into the build zone 123 and the cycle is repeated as described above.

Because this embodiment is not limited to material deposition devices that can be placed in close proximity to the build zone 123, it is expected to be especially useful for applying resin R and/or filler in a “patterned” configuration (e.g. a layer comprising one or more circles, stripes, rectangles, triangles, or any other shape other than a complete uniform coverage of the build plate 12). This could also be done with multiple different resins R and/or fillers. This embodiment is especially suitable for use with the material depositor 216 described above and shown in FIG. 12. Optionally, alignment means (pins, guides, kinematic couplings etc.) may be provided to ensure repeatable positioning (e.g. location and orientation) of the build plate 12 within the loading zone 125. In the illustrated example, retractable pins 129 are shown which register with corresponding blind holes (not shown) in the build plate 12.

The method described herein has several advantages over the prior art. In particular, it eliminates a major pathway for build failures in vat-based photopolymerization. It also potentially has lower cost, less material waste, and higher process speed compared to prior art tape casting methods. As compared to in-situ cleaning of the build plate, the method described herein is not limited other than by the time required for the transport mechanism to move a fresh build plate from the loading zone to the build zone. The present method also avoids any problems that might occur from in-situ application of the curable material on the build plate.

The foregoing has described a method and apparatus for additive manufacturing. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. An additive manufacturing apparatus, comprising:
a build plate, at least a portion of which is transparent, the build plate defining a build surface;
a plate transport mechanism operable to selectively move the build plate into or out of a build zone defined within the apparatus;
a material depositor operable to deposit a radiant-energy-curable resin on the build surface;
a stage positioned adjacent the build zone and configured to hold a stacked arrangement of one or more cured layers of the resin;
a mechanism operable to manipulate a relative position of the build plate and the stage; and
a radiant energy apparatus positioned adjacent to the build zone opposite to the stage, and operable to generate and project radiant energy through the build plate in a predetermined pattern.

2. The apparatus of claim 1, wherein the material depositor is configured to deposit the curable resin on the build surface within the build zone.

3. The apparatus of claim 1, wherein the material depositor is configured to deposit the curable resin on the build surface outside the build zone.

4. The apparatus of claim 1, wherein the plate transport mechanism is operable to selectively move the build plate from a loading zone to or from the build zone.

5. The apparatus of claim 4, wherein the plate transport mechanism is operable to selectively move the build plate from an unloading zone to or from the build zone.

6. The apparatus of claim 1 further comprising a recoater operable to level a layer of the resin.

7. The apparatus of claim 1 where the material depositor is configured to selectively deposit more than one resin.

8. The apparatus of claim 1 wherein at least a portion of the build surface includes a non-stick coating.

9. The apparatus of claim 1 wherein at least a portion of the build surface includes a structured surface roughness effective to create a non-stick effect.

10. The apparatus of claim 1 wherein at least a portion of the build plate is oxygen-permeable.

11. A method for producing a component layer-by-layer, comprising the steps of:
preparing a build plate including at least a portion which is transparent, the build plate defining a build surface which has a radiant-energy-curable resin deposited thereupon;
within a build zone of an additive manufacturing apparatus, positioning a stage such that at least one of the stage and a portion of the component already present on the stage contact the resin;
selectively curing the resin, using an application of radiant energy in a specific pattern, so as to define the geometry of a cross-sectional layer of the component;
moving the build plate and the stage relatively apart so as to separate the component from the build surface;
transporting the build plate out of the build zone; and
repeating the steps of preparing, positioning, curing, and transporting for a plurality of layers until the component is complete.

12. The method of claim 11 wherein the step of preparing the build plate comprises:
transporting a clean build plate into the build zone; and
depositing the resin on the build surface.

13. The method of claim 11 wherein the step of preparing the build plate comprises:
depositing the resin on the build surface of a clean build plate, while the build plate is outside of the build zone; and
transporting the build plate into the build zone.

14. The method of claim 11 wherein a fresh build plate is prepared for each layer.

15. The method of claim 11 further comprising cleaning at least one of the component and the stage, wherein the cleaning is carried out after the step of moving the build plate and the stage relatively apart.

16. The method of claim 15 wherein the step of cleaning includes contacting at least one of the component and the stage with a cleaning fluid.

17. The method of claim 16 wherein the step of cleaning includes introducing relative movement between the cleaning fluid and at least one of the component and the stage.

18. The method of claim 16 wherein the step of cleaning includes:
moving a vat containing a cleaning fluid into the build zone;
moving the stage so as to contact at least one of the component and the stage with the cleaning fluid; and
moving the stage so as to separate the stage and the component from the cleaning fluid.

19. The method of claim 11 wherein the resin is deposited such that the resin in at least one of the layers has a different composition than the resin in another one of the layers.

20. The method of claim 11 wherein at least one of the layers is divided into two or more sections, and the resin is applied such that the resin in at least one of the sections has a different composition then the resin in another one of the sections.

21. The method of claim 11 wherein the application of radiant energy is applied by projecting a patterned image comprising a plurality of pixels.

22. The method of claim 21 wherein the patterned image is shifted during the application of radiant energy.

23. The method of claim 21 wherein additional radiant energy is applied by scanning at least one build beam over the surface of the resin.

24. The method of claim 11 wherein the radiant energy is applied by scanning at least one build beam over the surface of the resin.

25. The method of claim 11 where the resin contains a mixture of more than one material.

26. The method of claim 11 wherein a non-stick coating is applied to the build surface prior to the step of depositing.

27. The method of claim 11 wherein a non-stick film is applied to the build surface before the step of curing and is removed after the curing step is completed.

28. The method of claim 11 wherein the resin includes a particulate material filler.

29. The method of claim 28 further comprising sintering the component to burn out the cured resin and consolidate the filler.

30. The method of claim 29 further comprising infiltrating a lower-melting-temperature material into the component during or after sintering.
